(19) United States
(12) Patent Application Publication
(10) Pub. No.: US 2009/0168177 A1
(43) Pub. Date: Jul. 2, 2009

(54) ACTIVE REFLECTIVE WARNING APPARATUS

(75) Inventors: Yu-Jen Tseng, TAIPEI (TW); Aileen Shaw, ROWLAND HEIGHTS, CA (US)

Correspondence Address: PAI PATENT & TRADEMARK LAW FIRM, 1001 FOURTH AVENUE, SUITE 3200, SEATTLE, WA, 98154, US

(73) Assignee: Yu-Jen Tseng, TAIPEI (TW)

(21) Appl. No.: 11/964,659

(22) Filed: Dec. 26, 2007

(51) Int. Cl. G02B 5/124

(52) U.S. Cl. 359/530

(57) ABSTRACT

The active reflective warning apparatus includes a transparent housing having a clear surface, a glittering retroreflective sheeting applied on the clear surface of the transparent housing for reflecting an external light, and a light-emitting unit disposed in the transparent housing. The light emitting from the light-emitting unit may emit through the clear surface and the glittering retroreflective sheeting.

### BACKGROUND

1. Field of Invention

The present invention relates to warning apparatus for vehicles. More particularly, the present invention relates to active reflective warning apparatus for vehicles.

2. Description of Related Art

Conventional passive reflective apparatuses, such as traffic directions, traffic signs, and vehicle reflectors have been wildly use in common life. Most of the passive reflective apparatuses are applied with a reflective material. The passive reflective apparatus may reflect an external light illuminating to the passive reflective apparatus. The less intensity of the external light, the less reflection intensity of the passive reflective apparatus may provide. The passive reflective apparatus cannot function well when there is a weak external light. Thus, the drivers cannot identify the traffic direction easily, and the risk of traffic accident is increased.

The passive reflective apparatus needs the external light to provide warning function. If there is no external light, the passive reflective apparatus cannot provide warning function. The warning angle and the warning distance of the passive reflective apparatus are limited with the external light. The driver can only identify the traffic direction in the limited distance and the limited angle.

Refer to FIG. 1. FIG. 1 illustrates an embodiment of a traditional reflective warning apparatus. The reflective surface of the traditional reflective warning apparatus 100 is divided into a reflective section 110 and an emitting section 120. The reflective section 110 may surround the emitting section 120. The traditional reflective warning apparatus 100 may have at least a light-emitting device 122 disposed behind the emitting section 120. The reflective section 110 consisted of a reflective lens to reflect the external light. The internal light cannot emit through the reflective section 110 from the light-emitting device 122.

The emitting section 120 of the traditional reflective warning apparatus 100 may emit light from the light-emitting device 122, but the emitting section 120 is lack of the reflective function to reflect the external light. The area of the reflective section 110 consisted of the reflective lens of this embodiment is limited with adding the emitting section 120, thus the reflecting effect of the traditional reflective warning apparatus 100 is reduced.

### SUMMARY

The present invention provides an active reflective warning apparatus. The active reflective warning apparatus includes a transparent housing having a clear surface, a glittering retroreflective sheeting applied on the clear surface of the transparent housing for reflecting an external light, and a light-emitting unit disposed in the transparent housing. The light emitting from the light-emitting unit may emit through the clear surface and the glittering retroreflective sheeting.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an embodiment of a traditional reflective warning apparatus;

FIG. 2A and FIG. 2B are a side view diagram and a front view diagram of an embodiment of the active reflective warning apparatus of the invention;

FIG. 3A and FIG. 3B are a side view diagram and a front view diagram of another embodiment of the active reflective warning apparatus of the invention;

FIG. 4A and FIG. 4B are front view diagrams of different embodiments of the active reflective warning apparatus; and

FIG. 5A and FIG. 5B are oblique diagrams of different embodiments of the active reflective warning apparatus of the invention.

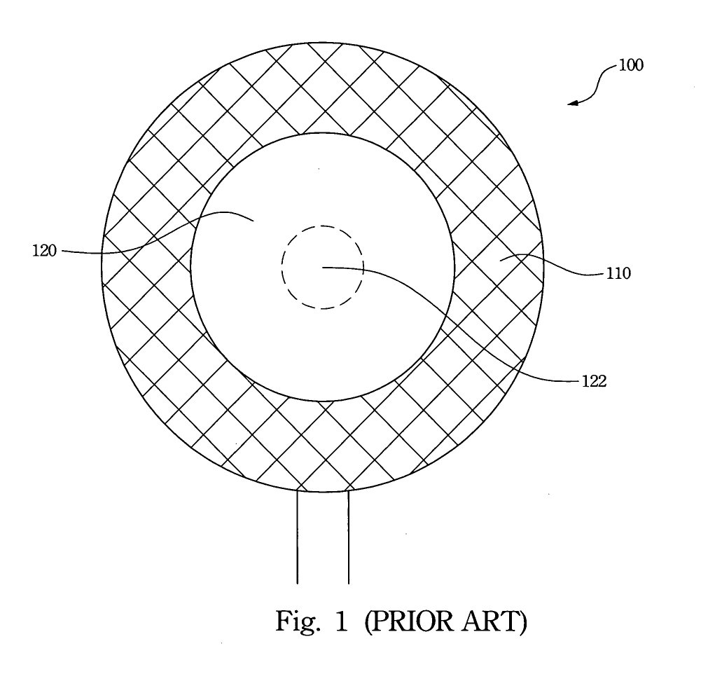

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

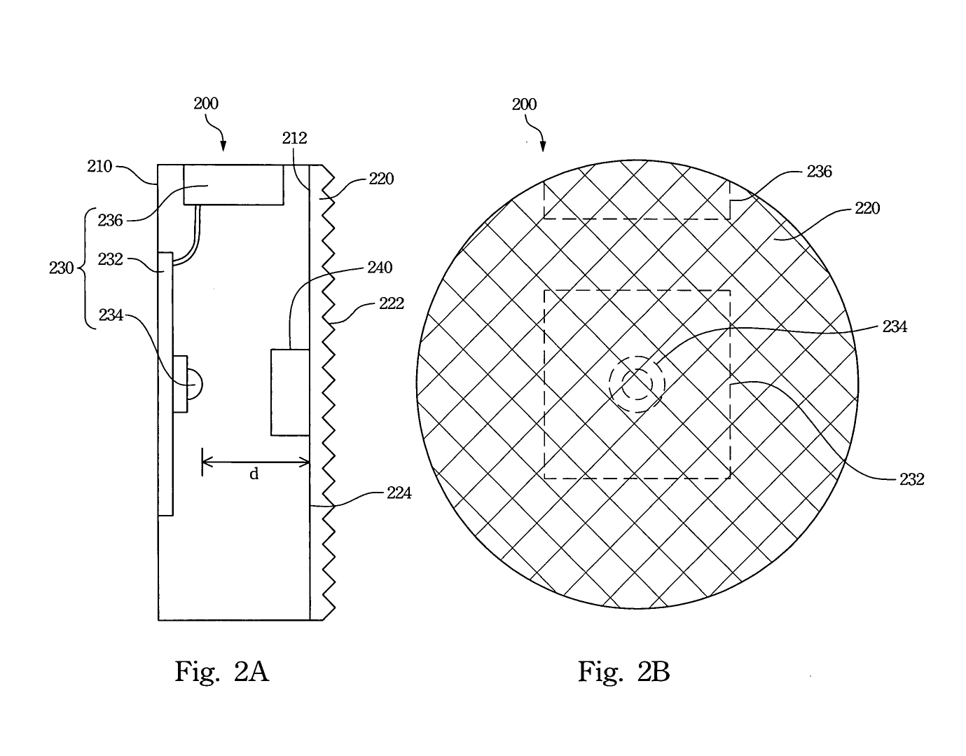

Refer to FIG. 2A and FIG. 2B. FIG. 2A and FIG. 2B illustrate a side view diagram and a front view diagram of an embodiment of the active reflective warning apparatus of the invention. The active reflective warning apparatus 200 includes a transparent housing 210, a glittering retroreflective sheeting 220, and a light-emitting unit 230 disposed in the transparent housing 210. The transparent housing 210 has a clear surface 212, and the glittering retroreflective sheeting 220 is applied on the clear surface 212. The glittering retroreflective sheeting 220 is pervious to light. The glittering retroreflective sheeting 220 may reflect an external light.

The glittering retroreflective sheeting 220 may be a sheeting conforming to the standard test of American Society for Testing Material (ASTM) D 4956-04. For example, the glittering retroreflective sheeting 220 may be a glittering cube-corner retroreflective sheeting made by the method as disclosed in U.S. Pat. No. 5,770,124. The front 222 of the glittering retroreflective sheeting 220 may be carved with a plurality of microprismatic cube-corner to reflect the external light. The light emitting from the light-emitting unit 230 may emit from a back 224 of the glittering retroreflectuve sheeting 220.

The range of the light receiving angle of the glittering retroreflective sheeting 220 is from 0 degree to 180 degree. The prefer observation angle of the glittering retroreflective sheeting 220 for drivers or passerby is from 35 degree to 115 degree. The glittering retroreflective sheeting 220 is pervious to light, thus the light-emitting unit 230 to emit light may be disposed behind the glittering retroreflective sheeting 220. The warning angle of the active reflective warning apparatus 200 may be enlarged to 0 degree to 180 degree with the light-emitting unit 230, but the area of the glittering retroreflective sheeting need not to be reduced.

The active reflective warning apparatus 200 may warn the driver actively before the external light from the front blinker illuminating on the glittering retroreflective sheeting 220 with the light emitting from the light-emitting unit 230. The active reflective warning apparatus 200 in this embodiment may reflect the external light passively or emit light actively. The glittering retroreflective sheeting 220 is applied on the whole clear surface 212 completely.

The back 224 of the glittering retroreflective sheeting 220 may be glued on the clear surface 212. The glittering retroreflective sheeting 220 is applied on the clear surface 212 completely. The light from the light-emitting unit 230 may emit through the clear surface 212 and the glittering retroreflective sheeting 220. In another embodiment, the clear surface 212 may have an opening, and the glittering retroreflective sheeting 220 may seal the opening of the clear surface 212.

The light-emitting unit 230 includes a circuit board 232, a light-emitting device 234 disposed on the circuit board 232, and a power 236 connecting to the circuit board 232. The light-emitting device 234 may be a light emitting diode. The light-emitting device 234 may be disposed corresponding to the middle of the glittering retroreflective sheeting 220. The power 236 may be a direct current. The power 236 may be a solar battery. The solar battery of the power 236 may be arranged on a top of the transparent housing 210 for receiving sunlight.

The active reflective warning apparatus 200 further includes a lens group 240 disposed between the clear surface 212 and the light-emitting device 234. The lens group 240 may be a combination of a concave lens and a convex lens. The light shape may be adjusted with the lens group 240. The light emitting from the light-emitting device 234 may be projected on the glittering retroreflective sheeting 220 equally with altering the distance d between the lens group 240 and the glittering retroreflective sheeting 220. In another embodiment, the lens group 240 may be a collimator secured on the light-emitting device 234.

The light from the light-emitting unit 230 may emit through the clear surface 212 and the glittering retroreflective sheeting 220, thus the clear surface 212 may need not to be divided into the emitting section and the reflective section as the traditional one. The glittering retroreflective sheeting 220 is applied on the whole clear surface 212 completely. The active reflective warning apparatus 200 may warn the drivers before the external light from the front blinker illuminating to glittering retroreflective sheeting 220 with the light emitting from the light-emitting unit 230.

The active reflective warning apparatus 200 may be a bicycle or vehicle reflector. The active reflective warning apparatus 200 may also be a traffic control signs or a delineator.

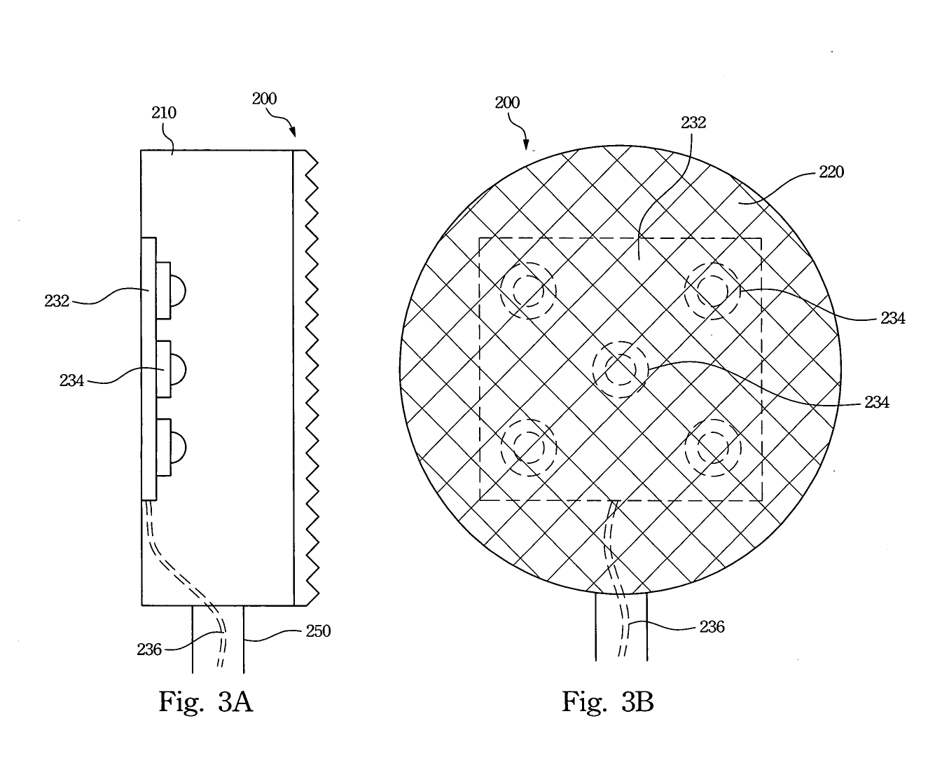

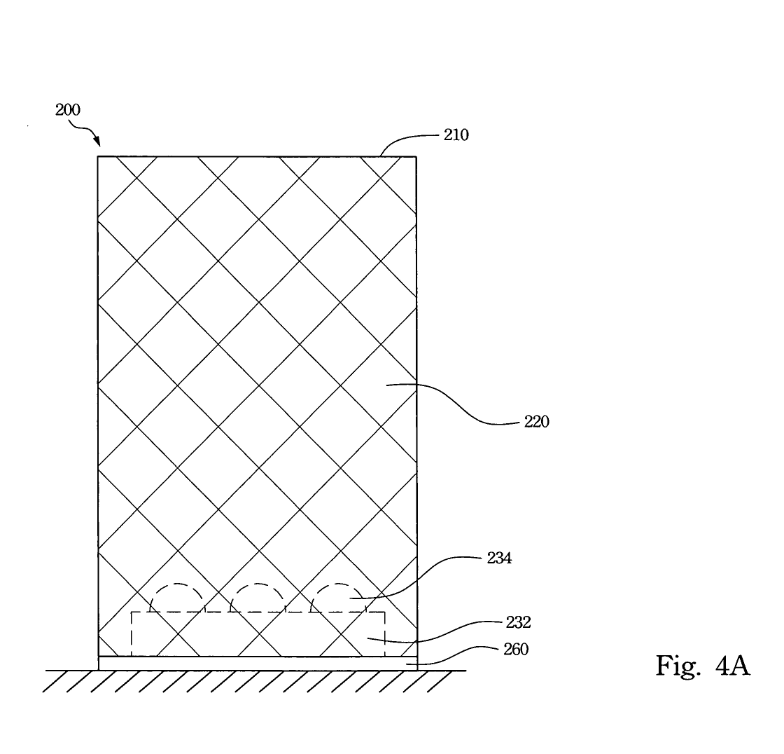

Refer to FIG. 3A and FIG. 3B. FIG. 3A and FIG. 3B illustrate a side view diagram and a front view diagram of another embodiment of the active reflective warning apparatus of the invention. The active reflective warning apparatus 200 may be the delineator. The active reflective warning apparatus 200 may further include a brace 250 disposed on a bottom of the transparent housing 210 to secure the active reflective warning apparatus 200 on a plane. The light-emitting unit 230 may include a plurality of the light-emitting devices 234. The light-emitting devices 234 may be scattered disposed on the circuit board 232. The power 236 may be an alternating current. The delineator of the active reflective warning apparatus 200 may be settled on the roadside, especially on the corner or on the hill road for highly increasing the warning range.

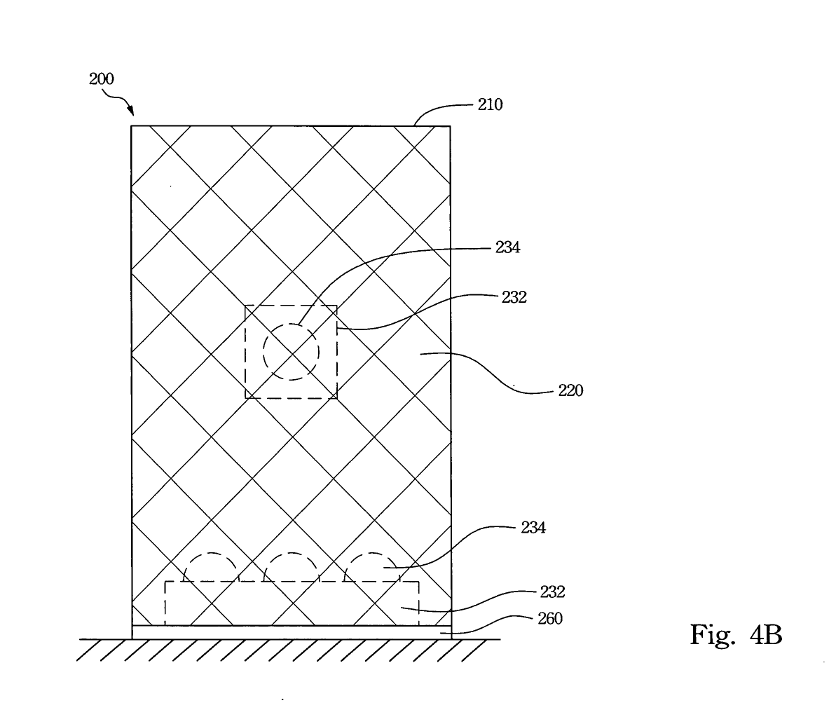

Refer to FIG. 4A and FIG. 4B. FIG. 4A and FIG. 4B illustrate front view diagrams of different embodiments of the invention. The shape of the transparent housing 210 may be a rectangle. The light-emitting device 234 and the circuit board 232 may be disposed on the bottom of the transparent housing 210 as shown in FIG. 4A. The light emitting from the light-emitting device 234 may be guided to the whole glittering retroreflective sheeting 220, thus the glittering retroreflective sheeting may emit light actively. The active reflective warning apparatus 200 may further include a glue 260 disposed on the bottom of the transparent housing 210 to secure the active reflective warning apparatus 200 an the plane. The light-emitting devices 234 may also be arranged as shown in FIG. 4B. The active reflective warning apparatus 200 may be a barricades, or interior signs.

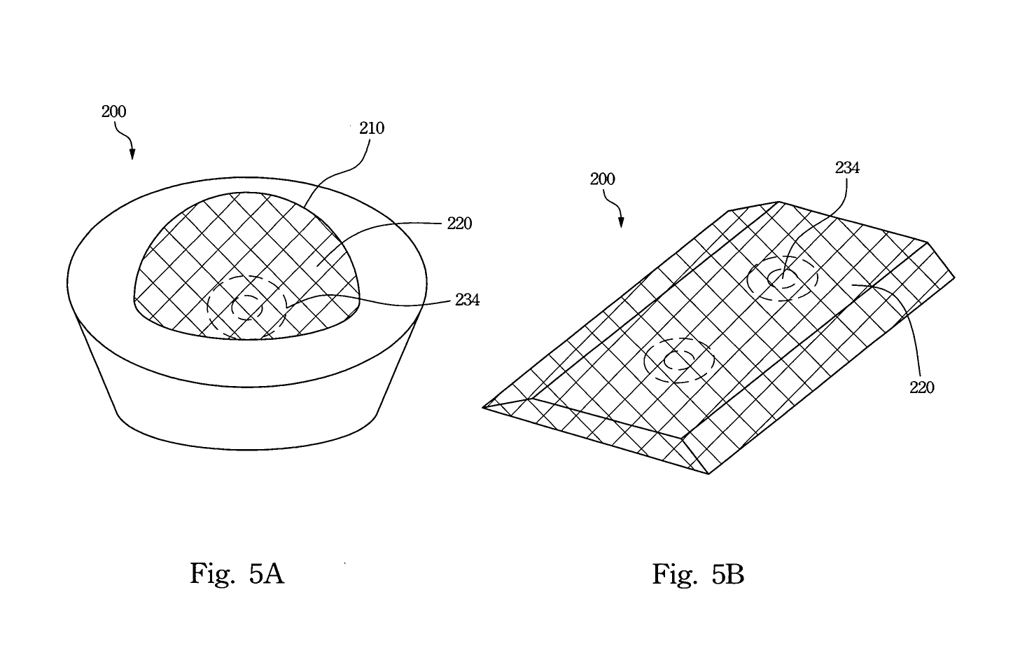

Refer to FIG. 5A and FIG. 5B. FIG. 5A and FIG. 5B illustrate oblique diagrams of different embodiments of the active reflective warning apparatus of the invention. The active reflective warning apparatus 200 may be a pavement marker. The glittering retroreflective sheeting 220 pervious to light may be applied on the transparent housing 210. The pavement marker of the active reflective warning apparatus 200 may have the light-emitting device 234 disposed within to emit light through the glittering retroreflective sheeting 220.

The active reflective warning apparatus may be utilized in the delineator, the pavement marker, the vehicle reflector, the bicycle reflector, or other warning apparatus for vehicles. The glittering retroreflective sheeting of the active reflective warning apparatus may be printed with an ink pervious to light to mark a specific traffic sign.

The active reflective warning apparatus may reflect external light illuminating to the glittering retroreflective sheeting to warn the drivers passively. The active reflective warning apparatus may also emit light of the light-emitting device through the glittering retroreflective sheeting to extend the warning range and to warn the drivers actively. The glittering retroreflective sheeting is applied on the whole clear surface completely.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active reflective warning apparatus comprising:
a transparent housing having a clear surface;
a glittering retroreflective sheeting applied on the clear surface of the transparent housing for reflecting an external light; and
a light-emitting unit disposed in the transparent housing, wherein a light emitting from the light-emitting unit emits through the clear surface and the glittering retroreflective sheeting.

2. The active reflective warning apparatus of claim 1, wherein the glittering retroreflective sheeting is applied on the clear surface completely.

3. The active reflective warning apparatus of claim 1, wherein the light-emitting unit comprises a circuit board fixed in the transparent housing, a light-emitting device disposed on the circuit board, and a power connecting to the circuit board.

4. The active reflective warning apparatus of claim 3, wherein the power is an alternating current.

5. The active reflective warning apparatus of claim 3, wherein the power is a direct current.

6. The active reflective warning apparatus of claim 5, wherein the power is a solar battery; the transparent housing has a top, and the solar battery is arranged on the top of the transparent housing.

7. The active reflective warning apparatus of claim 3, further comprising a lens group disposed between the light-emitting device and clear surface of the transparent housing.

8. The active reflective warning apparatus of claim 1, wherein a warning angle of the active reflective warning apparatus is from 0 degree to 180 degree.

9. The active reflective warning apparatus of claim 1, wherein the light-emitting unit comprises a circuit board fixed in the transparent housing, a plurality of light-emitting devices scattered disposed on the circuit board, and a power connecting to the circuit board.

10. The active reflective warning apparatus of claim 1, wherein the active reflective warning apparatus is a pavement marker.

11. The active reflective warning apparatus of claim 1, wherein the active reflective warning apparatus is a delineator.

12. The active reflective warning apparatus of claim 1, wherein the active reflective warning apparatus is a vehicle reflector.

13. The active reflective warning apparatus of claim 1, wherein the clear surface has an opening, and the glittering retroreflective sheeting seals the opening of the clear surface.

14. The active reflective warning apparatus of claim 1, further comprising a glue disposed on a bottom of the transparent housing to secure the active reflective warning apparatus on a plane.

15. The active reflective warning apparatus of claim 1, further comprising a brace disposed on a bottom of the transparent housing to secure the active reflective warning apparatus on a plane.
